(19) United States
(12) Patent Application Publication
(10) Pub. No.: US 2004/0167812 A1
(43) Pub. Date: Aug. 26, 2004

(54) Counterparty arrangement and method for use in hedging and financial derivative transactions

(76) Inventor: James Edison Haney II, Jersey City, NJ (US)

Correspondence Address: attn: Robert T. Tobin, KENYON & KENYON, One Broadway, New York, NY, 10004, US

(21) Appl. No.: 10/374,309

(22) Filed: Feb. 25, 2003

(51) Int. Cl. G06F 17/60

(52) U.S. Cl. 705/8

(57) ABSTRACT

A method and arrangement for the organization and structure of a derivative counterparty which is formed to facilitate hedging and derivative transactions, including swap transactions, in which the method includes establishing a counterparty entity as a joint venture between the customer and a plurality of common members, providing a portion of capital to the counterparty entity from each of the plurality of common members and the customer, providing another portion of the capital to the counterparty, and purchasing assets for executing a derivative transaction between the counterparty and the customer using the capital provided to the counterparty, in which operations of the counterparty are economically and/or financially independent of the plurality of common members and the customer.

### FIELD OF THE INVENTION

The present invention relates to the organization and structure of a derivative counterparty, which is formed to facilitate hedging and derivative transactions, including swap transactions.

### BACKGROUND INFORMATION

In the financial markets, derivative instruments, including swaps and options, are used in hedging strategies to counterbalance or “hedge” a broad range of risks. Those risks can include risks associated with changes in market value and cash flows associated with a business enterprise's assets, liabilities and activities. In accordance with their use in managing financial risk, hedging strategies have been applied to many different financial products.

It has been suggested, for example, that a hedging strategy using swaps may be used to hedge risks associated with non-qualified deferred compensation plans offered by employers to employees, in which employees defer a portion of their compensation for later payment in a tax deferred manner. Some employers offer employees, within their non-qualified deferred compensation plans, the ability to receive returns on their deferred compensation as if that deferral had been invested in various investment vehicles. The initial deferral combined with return on these referenced investments represent a liability to the employer, which must be paid to the employees upon withdrawal from the plan.

While hedging such a liability using derivatives is believed to represent a straightforward application of well established hedging strategies, it is believed that for some financial intermediaries, actually implementing such hedging strategies in the real world and in a practical way is problematic. In this regard, the way in which the counterparty is arranged or structured is believed to be especially important in providing a real world and practical implementation of hedging strategies for various financial products, including, for example, non-qualified deferred compensation plans.

It is therefore believed that there is a need for a counterparty arrangement or structure that facilitates the real world and practical implementation of hedging strategies involving financial derivatives, including, for example, swap transactions.

### SUMMARY OF THE INVENTION

One exemplary method of the present invention is directed to facilitating a derivative transaction by and between a derivative user or users (“customer” or “customers”) and an entity that is a derivative product issuer (“counterparty”). The counterparty is a joint venture between the customer(s) and a plurality of common members, with a portion of the counterparty capital provided by each of the plurality of common members and the customer(s), and another portion of the capital provided by a third party lender. The exemplary method further includes executing a derivative transaction between the counterparty and the customer and engaging in the purchase of assets using the capital provided to the counterparty. In accordance with the exemplary method, the economic or financial self-sufficiency of the counterparty is independent of further financial support from the plurality of common members and the customer(s).

In an embodiment of the above exemplary method, the plurality of common members are provided with voting rights for the counterparty, and the plurality of common members each individually hold a non-unilateral, non-controlling share of the voting rights.

In yet another embodiment, the above exemplary method is directed to hedging the payment obligations of the counterparty under the derivative transaction by using the assets purchased for executing the derivative transaction.

In yet another embodiment of the above exemplary method, the derivative transaction includes a swap transaction, which, according to one exemplary implementation, may be a total return swap transaction. According to this exemplary implementation, the total return swap transaction may be used to hedge risks associated with an employee non-qualified deferred compensation plan.

In yet another embodiment of the above exemplary method, the counterparty entity is established as a limited liability entity.

In yet another embodiment of the above exemplary method, at least one third party lender provides the other portion of the capital to the counterparty.

In yet another embodiment of the above exemplary method, performance of at least one of the counterparty and the customer in the derivative transaction is guaranteed through a financial institution. The assets purchased for the counterparty with the capital may be used to hedge payment obligations of the counterparty under the derivative transaction with the customer, and the financial institution guarantees only the performance of the customer.

In yet another embodiment of the above exemplary method, the other portion of the capital by the third party lender is provided by the counterparty issuing commercial paper to at least one third party lender.

In yet another embodiment of the above exemplary method, the plurality of common members and the customer provide a minority portion of the capital to the counterparty. According to one implementation, the plurality of members and the customer provide in total approximately ten percent of the capital to the counterparty.

In yet another embodiment of the above exemplary method, the counterparty entity is established as a limited liability company (LLC).

Another exemplary embodiment of the present invention is directed to a counterparty arrangement to facilitate and enter into a derivative transaction with a customer(s), the counterparty arrangement including a joint venture having a plurality of common members, and at least one preferred member, a customer being one of the at least one preferred member, wherein each of the plurality of common members and the at least one preferred member contribute capital to the joint venture, and the joint venture is economically and/or financially self-sufficient from the counterparty and is independent of further economic and/or financial support from the plurality of common members and the at least one preferred member.

In an embodiment of the above counterparty arrangement, the joint venture is a limited liability entity.

In yet another embodiment of the above counterparty arrangement, the joint venture is a limited liability company.

In yet another embodiment of the above counterparty arrangement, the plurality of common members have voting rights, one of the plurality of common members manages the joint venture, and each of the plurality of common members has a non-unilateral, non-controlling share of the voting rights in the joint venture.

In yet another embodiment of the above counterparty arrangement, the derivative transaction includes a swap transaction. According to an implementation of this embodiment, the swap transaction includes a total return swap transaction, which may be used to hedge risks associated with an employee non-qualified deferred compensation plan.

In yet another embodiment of the above counterparty arrangement, the plurality of common members and the at least one preferred member provide a percentage of a total amount of capital to the joint venture,the capital being used to fund the derivative transaction with the customer. According to an implementation of this embodiment, the percentage is less than about 20 percent.

Another exemplary method of the present invention is directed to facilitating a derivative transaction with a customer using a counterparty arrangement by establishing a counterparty entity as a joint venture between the customer and a plurality of common members, providing a portion of the capital to the counterparty from each of the plurality of common members and the customer, providing another portion of the capital to the counterparty, purchasing assets for executing a derivative transaction between the counterparty and the customer using the capital provided to the counterparty, hedging payment obligations of the counterparty under the derivative transaction by using the assets purchased for executing the derivative transaction, and guaranteeing through a financial institution performance of at least one of the counterparty and the customer in the derivative transaction, the counterparty being economically and/or financially independent of the plurality of common members and the customer.

### BRIEF DESCRIPTION OF THE DRAWINGS

FIG. 1 is a block diagram of an exemplary counterparty arrangement according to the present invention.

FIG. 2 is a block diagram of an exemplary derivative transaction involving a swap, in which the exemplary counterparty arrangement of FIG. 1 engages in the swap transaction.

FIG. 3 is a block diagram showing an exemplary method for the counterparty to purchase and finance the underlying assets according to the exemplary derivative transaction of FIG. 2. FIG. 4 is a flow chart of an exemplary method for facilitating a derivative transaction with a customer using the exemplary counterparty arrangement of FIG. 1 and FIG. 2.

### DETAILED DESCRIPTION

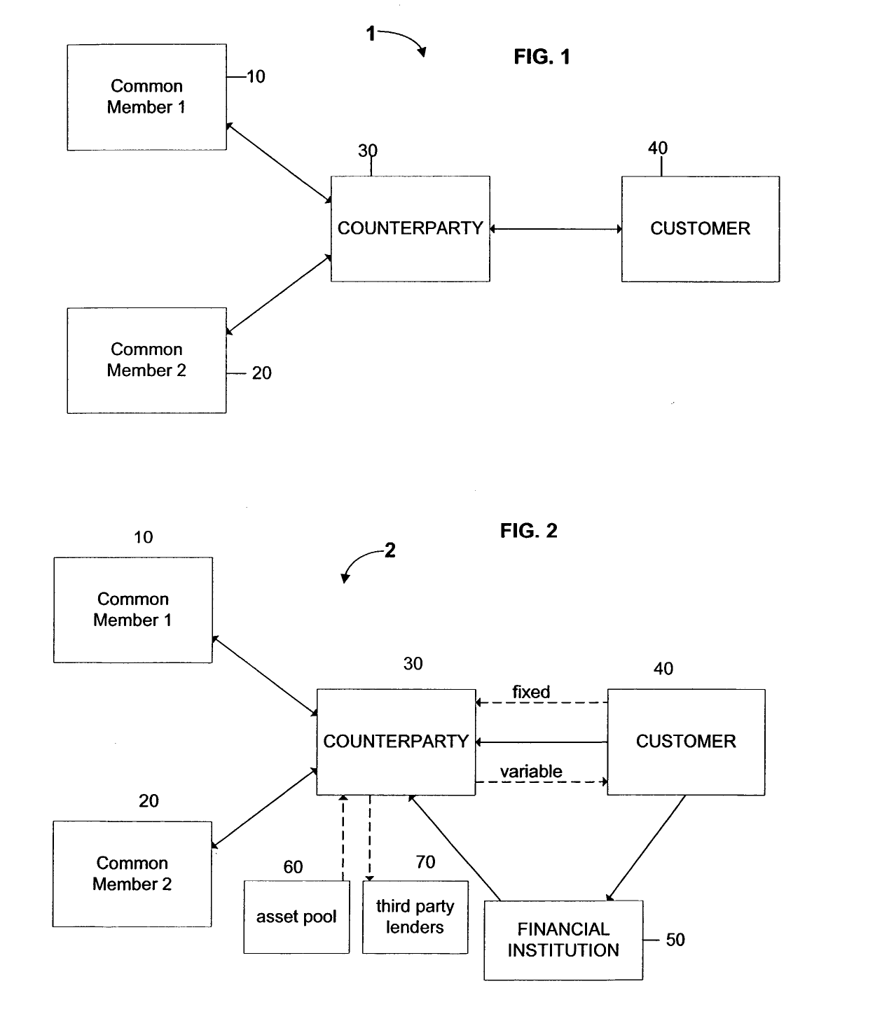

FIG. 1 shows an exemplary embodiment of the organization and structure of a derivative counterparty 1 which is formed to facilitate hedging and derivative transactions. As shown in FIG. 1, a counterparty 30 is arranged or structured as a joint venture 1 between three entities. The three entities include a first common member 10 (“Common Member 1”), a second common member 20 (“Common Member 2”), and a third entity denoted as Customer 40. The term “common member” in this context is used to denote a member that has certain voting rights in the joint venture 1 regardless of how the counterparty 30 is formed or incorporated. For example, according to an exemplary embodiment, the counterparty 30 may be formed as a limited liability company (LLC), which should offer the advantages of limited liability and pass-through (partnership) taxation for the members of the limited liability company (LLC).

In the exemplary embodiment, the Common Member 1 and the Common Member 2 are established as the voting members of the limited liability company (LLC). According to one exemplary implementation, both the Common Member 1 and the Common Member 2 are given 50% of the voting rights for the counterparty 30, and one of the common members, Common Member 1, is vested with management responsibility as a managing member. The Customer 40 is established as a preferred member having no voting rights, but may have certain preferential rights with respect to compensation for its financial contributions to the counterparty 30. The joint venture 1 may include a plurality of preferred members in addition to Customer 40. Also, the counterparty 30 may be formed as a corporation or any other present or prospectively envisioned business entity that provides legal advantages such as limited liability (such as a Limited Liability Corporation), tax advantages such as pass-through taxation and/or other legal, tax and/or financial advantages.

Regardless of how the counterparty 30 is formed or incorporated, it is arranged or structured to be economically and/or financially self-sufficient from members 10 or 20, or the customer 40, or each of any plurality of other possible preferred members. In the exemplary embodiment described above, since neither the Common Member 1 nor the Common Member 2 hold more than 50% of the voting rights, neither of the common members individually has a unilateral controlling ownership that could cause the counterparty 30 to be deemed a controlled subsidiary of either of the common members. The common members 10, 20 may contribute any percentage of capital, and the customer 40 may contribute a comparable or any different amount of capital with respect to the common members. However, no common member may contribute enough capital such that it obtains a sufficient voting interest to control the counterparty 30.

As will be described further below, the remaining and main portion of the capitalization is borrowed from third parties or a capital market 70. The capital vested in the counterparty 30 may be used to purchase underlying assets pursuant to a hedging strategy as will be described below.

There are several reasons why it is believed to be advantageous to establish the counterparty 30 as an economically and/or financially independent entity that is not a controlled subsidiary of any of its constituent members. By financial independence, an entity is capable of raising capital necessary for operations without incurring additional subordinate equity interests. By economic independence, an entity is able to conduct business without relation to the common members. For example, as an economically independent entity, the counterparty could conduct distributions without regard to the common members. Furthermore, as an economically and/or financially and independent entity, the counterparty 30 is able to or at least better able to carry out its focused objective of facilitating derivative transactions without the operational, regulatory, financial and economic burdens of being one part of a more diverse range of operations. It is also believed that the risks of the counterparty 30 are isolated for easier identification, management and control, providing the counterparty with access to a lower cost of capital. This capital efficiency is beneficial to the customer, the common members and the capital market as whole. One possible result, under GAAP accounting principles, of structuring the counterparty in this manner is that it may maintain a separate balance sheet that does not become consolidated or included in the balance sheets of any of the common members 10 or 20, or the customer 40.

Additionally, if the counterparty 30 should maintain a separate balance sheet, any assets or liabilities associated with the counterparty 30 will not be attributed to any of the common members 10 or 20 or the customer 40. Moreover, maintaining the economic activities of the counterparty in isolation from the common members allows the counterparty to obtain a stand-alone financial rating. It may also be advantageous to structure the counterparty as a limited liability entity (such as, for example, a limited liability corporation (LLC) or a corporation) that protects the common members 10 or 20 and/or the customer 40 from being held legally liable for the debts of the counterparty 30 beyond the financial contribution that they invest in the counterparty 30.

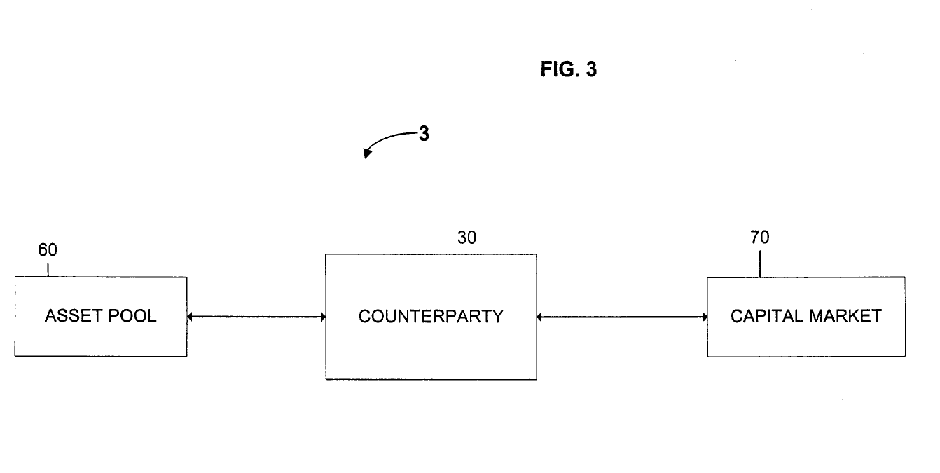

FIG. 2 shows a block diagram of an exemplary derivative transaction 2 involving a swap in which an exemplary counterparty arrangement or structure according to the present invention engages in a financial derivative transaction. It is understood that using a swap in the derivative transaction is exemplary, and that other derivative products, such as, for example, options, futures, forward contracts, and any other available and suitable derivative financial instruments may also be used in the context of a derivative transaction facilitated by the counterparty 30. As shown in FIG. 2, the Customer 40 enters into a swap transaction with the counterparty 30. According to an exemplary embodiment, the customer 40 may be an institution that is obligated to pay the total return on a certain pool of assets to a third party (not shown). In the exemplary swap transaction, the customer 40 agrees to pay a fixed interest rate on a notional amount of the pool of assets and to receive the total percentage return on the assets from the counterparty 30 for a certain length of time, which may be divided into periods for exchanging payments.

This type of transaction may be particularly useful in the case where the customer 40 is an employer that has implemented a non-qualified deferred compensation plan for employees. The plan sponsored by customer 40 is an uncertain and potentially costly liability, representing an economic and financial risk normally not associated with customer 40's business activities. Thus, the customer 40 enters into the transactional swap to pay a contractually certain amount (rate) for financial protection against the variable and uncertain return on the assets referenced by the plan. In this manner, the customer 40 may hedge itself against the economic and financial risks associated with the value of the its plan liability. The rate agreed upon may be the LIBOR (London Interbank Offer Rate) rate plus a fixed spread. It is believed that many business enterprises understand and are able to manage LIBOR costs and risks, as they may be standard in the financing of company operations. Swapping the uncertainty of the referenced assets for a LIBOR based payment should simplify the financial management of the customer 40.

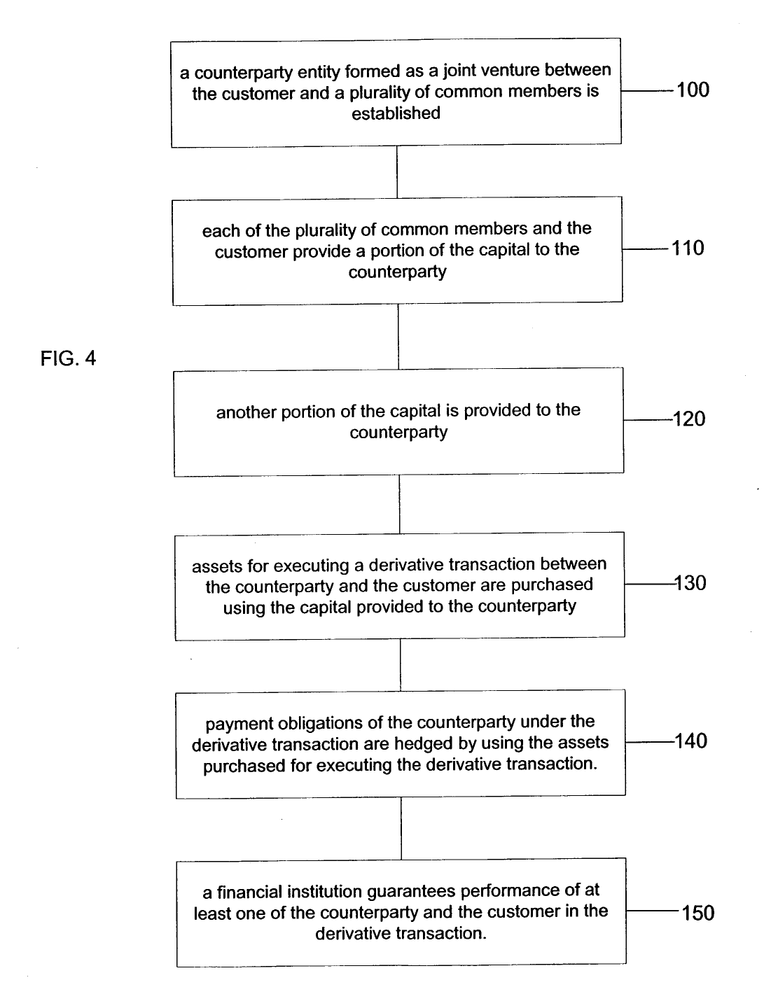

In the above-described derivative transaction, the counterparty 30 has taken on the economic exposure to the referenced assets and may also seek to hedge the exposure so that it can with greater certainty execute its obligations to pay the total return on the referenced assets under the swap transaction. To do so, the counterparty 30 may purchase the entire pool of assets 60 using its own assets and borrowed funds as shown in FIG. 3. In this case, the counterparty 30 would completely match its asset purchases (“matched assets”) with its obligations under the transaction. For example, if the counterparty 30 is obligated to pay the total return on equity shares A, B and C, then the counterparty 30 would match its obligations by purchasing equity shares A, B and C. Alternatively, the counterparty 30 may purchase a portion of the assets for which the total return is calculated, and/or different assets from those for which the total return is calculated. In the case of different assets, the assets are unmatched (“unmatched assets”) and the counterparty 30 assumes a level of financial risk with respect to the difference in the return between the assets it owns and the assets for which it is obligated to pay the total return.

In the above-described exemplary embodiment, the counterparty 30 obtains two (2) percent of the notional amount of funds required to purchase the pool of assets from each of the common members 10 and 20, and six (6) percent of the notional amount from the customer 40. According to this financial arrangement, the customer 40 becomes a partial owner of the asset pool 60 and therefore sits on both sides of the swap transaction, namely, as a part owner of the counterparty 30, and as the entity with which the counterparty 30 transacts in the swap. With only ten (10) percent of the notional amount of the asset pool 60 accounted for, the counterparty 30 finances the remaining ninety (90) percent by borrowing the remaining funds from third party lenders or capital markets 70. The counterparty 30 may finance the remaining ninety (90) percent by directly borrowing funds or by arranging to issue commercial paper in its own name in the capital markets 70. The counterparty 30 may generally be required to pay an interest rate on the capital that it borrows, regardless of whether this is on a loan or on commercial paper. The counterparty 30 is hedged to some extent against fluctuations in the valuation of the asset pool 60 since the counterparty 30 receives the appreciation of the assets that it owns (it is completely hedged if it owns matched assets), and simultaneously passes this return on to the customer 40. Therefore, if the counterparty 30 purchases matched assets, it will receive as net proceeds the difference or spread between the fixed rate payments it receives from the customer 40 on the swap transaction and the interest it pays on the capital it borrows from the third party lenders or capital markets 70.

As previously explained, the common members 10, 20 may contribute any percentage of capital, and the customer 40 may contribute a comparable or any different amount of capital with respect to the common members. However, no common member may contribute enough capital such that it obtains a sufficient voting interest to control the counterparty 30.

Since, as explained, the largest portion of the capital required to execute the hedging strategy is acquired from the third party lenders or capital markets 70, this capital can be easily obtained only if the credit rating of the counterparty 30 is high. That is, the third parties must have adequate assurance against the default of the counterparty 30. Since the counterparty 30 essentially passes through the fixed rate payments it receives from the Customer 40 to the third party lenders or capital markets 70 minus a spread (when the counterparty 30 owns matched assets), the default risk on the derivative transaction is the risk that the Customer 40 cannot pay the counterparty 30 the fixed rate payments and any payments for any depreciation of the asset pool 60, which renders the counterparty 30 unable to pass through the funds to make interest payments to the third party lenders or capital markets 70.

Thus, to facilitate financing, it is believed to be desirable (but not necessary) that there be some form of guarantee against the risk of the Customer 40 defaulting. According to an exemplary embodiment of the hedging strategy, the financial institution 50 acts as a “credit wrapper” to guarantee performance of the Customer 40 in the swap transaction. A guarantee is optional, especially where the risk reduction is accomplished through a diversified customer base. Although the financial institution is shown as a single entity, it is understood that any number of entities may participate in various ways in guaranteeing performance of the Customer 40 in the derivative transaction. With the performance guarantee provided by the financial institution 50, the counterparty 30 and the Customer 40 in the transaction may be given a high rating (such as, for example, AA or AAA rating) by a credit rating agency (such as, for example, Moodys or Standard & Poors) (which may be a prerequisite for obtaining the highest rated commercial paper (A1/P1 paper) in the capital markets 70) when this “credit wrapper” financial arrangement is selected for obtaining capital for the counterparty 30. An advantage of obtaining a high credit rating is that capitalization requirements are reduced. If the counterparty 30 and, in particular, the customer 40 are given a lower credit rating, the common members 10 and 20 and the customer 40 may be required to provide greater capital contributions to the counterparty 30. It may not be, however, necessary to obtain the highest credit rating in all cases. Thus, for example, where the counterparty 30 hedges on the swap with unmatched assets, the higher risks associated with hedging in this manner may cause a reduction in the credit rating of the counterparty 30, which may be acceptable to the parties involved.

Thus, the counterparty arrangement or structure 1 of FIG. 1 facilitates the real world and practical implementation of derivative transactions and related hedging strategies. Because the counterparty 30 is an economically and/or financially independent entity, the common members 10 and 20 and the customer 40 limit their exposure to their contributed capital and can profit from the derivative transactions that the counterparty 30 enters into without incurring the negative ramifications of other forms of organization and structure. It is believed that this provides a previously unavailable financial arrangement for financial institutions (such as, for example, insurance companies or banks) for engaging in derivative transactions that they might otherwise avoid because of the potential impacts on their broader range of activities. Furthermore, by establishing the counterparty 30 as a limited liability entity, there is no recourse to the common members 10 and 20 and the Customer 40 for any liabilities that the counterparty 30 may incur in the course of any derivative transactions that it may engage in. The counterparty 30 requires relatively limited capital contributions from the common members 10 and 20, since the largest portion of the capital required to enter the derivative transactions may be obtained from third party lenders or capital markets 70. Capitalization may be further facilitated by having the financial institution 50 guarantee the performance of the Customer 40 in the derivative transaction.

In accordance with the benefits provided by the counterparty arrangement or structure, an exemplary method 4 for facilitating a derivative transaction with a customer using the counterparty structure of FIG. 1 and/or FIG. 2 is shown in FIG. 4. In step 100 of the exemplary method, a counterparty entity constituting a joint venture between a customer and a plurality of common members is established. In step 110, each of the plurality of common members and the customer provide a portion of the capital to the counterparty, which portion may be a minority portion of the total capital. Another portion of the capital is provided to the counterparty in step 120, which may be obtained from unrelated third parties or capital markets 70. In step 130, assets for executing a derivative transaction between the counterparty and the customer are purchased using the capital provided to the counterparty. In step 140, the assets purchased are used to hedge payment obligations of the counterparty under the derivative transaction. In step 150, the performance of at least one of the counterparty and the customer in the derivative transaction is guaranteed through a financial institution 50. In this way, the activities of the counterparty 30 maintain complete economic and/or financial independence from the activities of the plurality of common members 10 and 20 and the customer 40.

What is claimed is:

1. A method to organize and structure a derivative counterparty which is formed to facilitate a derivative transaction with a customer, the method comprising:
establishing a counterparty entity as a joint venture between the customer and a plurality of common members;
providing a portion of capital to the counterparty entity from each of the plurality of common members and the customer;
providing another portion of the capital to the counterparty from at least one third party; and
purchasing assets for executing a derivative transaction between the counterparty and the customer using the capital provided to the counterparty;
wherein the counterparty is financially independent of the plurality of common members and the customer.

2. The method of claim 1, wherein the plurality of common members are provided with voting rights for the counterparty, and the plurality of common members hold a non-unilateral, non-controlling share of the voting rights.

3. The method of claim 1, further comprising:
hedging payment obligations of the counterparty under the executed derivative transaction by purchasing assets.

4. The method of claim 1, wherein the derivative transaction includes a swap transaction.

5. The method of claim 4, wherein the swap transaction includes a total return swap transaction.

6. The method of claim 5, wherein the total return swap transaction is used by the customer to hedge risks associated with an employee non-qualified deferred compensation plan.

7. The method of claim 1, wherein the counterparty entity is established as a limited liability entity.

8. The method of claim 1, wherein at least one third party lender provides the another portion of the capital to the counterparty.

9. The method of claim 8, wherein the another portion of the capital is provided by issuing commercial paper on behalf of the counterparty to the at least one third party lender.

10. The method of claim 8, further comprising:
guaranteeing through a financial institution performance of at least one of the counterparty and the customer in the derivative transaction.

11. The-method of claim 10, wherein the assets purchased for the counterparty hedge payment obligations of the counterparty under the derivative transaction with the customer, and the financial institution guarantees only the performance of the customer.

12. The method of claim 8, wherein the plurality of common members and the customer provide a minority portion of the capital to the counterparty.

13. The method of claim 12, wherein the plurality of members and the customer provide in total approximately ten percent of the capital to the counterparty.

14. The method of claim 1, wherein the counterparty entity is established as a limited liability company.

15. A counterparty arrangement to facilitate and enter into a derivative transaction with a customer, the counterparty arrangement comprising:
a joint venture having a plurality of common members, and at least one preferred member, the customer being one of the at least one preferred member;
wherein each of the plurality of common members and the at least one preferred member contribute capital to the joint venture, and the joint venture is financially independent of and is not a controlled subsidiary of any of the plurality of common members and the at least one preferred member.

16. The counterparty arrangement of claim 15, wherein the joint venture is an economically independent entity with respect to the plurality of common members and the at least one preferred member.

17. The counterparty arrangement of claim 15, wherein the joint venture is a limited liability company.

18. The counterparty arrangement of claim 15, wherein the plurality of common members have voting rights, one of the plurality of common members manages the joint venture, and each of the plurality of common members has a non-unilateral, non-controlling share of the voting rights in the joint venture.

19. The counterparty arrangement of claim 15, wherein the derivative transaction includes a swap transaction.

20. The counterparty arrangement of claim 19, wherein the swap transaction includes a total return swap transaction.

21. The counterparty arrangement of claim 20, wherein the total return swap is used to hedge risks associated with an employee non-qualified deferred compensation plan.

22. The counterparty arrangement of claim 15, wherein the plurality of common members and the at least one preferred member provide a percentage of a total amount of capital to the joint venture, the capital being used to fund the derivative transaction with the customer.

23. The counterparty arrangement of claim 22, wherein the percentage is less than about 15 percent.

24. A method to facilitate a derivative transaction with a customer using a counterparty arrangement, the method comprising:
establishing a counterparty entity as a joint venture between the customer and a plurality of common members;
providing a portion of the capital to the counterparty from each of the plurality of common members and the customer;
providing another portion of the capital to the counterparty;
purchasing assets for executing a derivative transaction between the counterparty and the customer using the capital provided to the counterparty;
hedging payment obligations of the counterparty under the derivative transaction by using the assets purchased for executing the derivative transaction; and
guaranteeing through a financial institution performance of at least one of the counterparty and the customer in the derivative transaction;
wherein operations of the counterparty are financially independent of the plurality of common members and the customer.

25. The method of claim 24, wherein the operations of the counterparty are economically independent of the plurality of common members and the customer.

26. The method of claim 1, wherein the counterparty is economically independent of the plurality of common members and the customer.
